(19) United States
(12) Patent Application Publication
(10) Pub. No.: US 2022/0033223 A1
(43) Pub. Date: Feb. 3, 2022

(54) AUTONOMOUS ELEVATOR CAR MOVERS CONFIGURED WITH COUPLING DEVICES FOR VIBRATION DAMPING

(71) Applicant: Otis Elevator Company, Farmington, CT (US)

(72) Inventors: Randy Roberts, Hebron, CT (US); Sam Thieu Wong, Bridgeport, CT (US); Kiron Bhaskar, Farmington, CT (US); Bruce Swaybill, Farmington, CT (US)

(21) Appl. No.: 16/943,574

(22) Filed: Jul. 30, 2020

(51) Int. Cl. B66B 9/02; B66B 7/04; B66B 1/32; B66B 5/02

(52) U.S. Cl. CPC B66B 9/02; B66B 7/048; B66B 2201/307; B66B 5/02; B66B 1/32

(57) ABSTRACT

Disclosed is a ropeless elevator system having a car mover operationally connected to an elevator car, the car mover configured to operate autonomously and move along a hoistway lane, thereby moving the elevator car along the hoistway lane, wherein the car mover is connected to a top or bottom of the elevator car, via a coupling device.

### BACKGROUND

Embodiments described herein relate to an elevator system and more specifically to autonomous elevator car movers configured with coupling devices for vibration damping.

An autonomous elevator car mover may use motor-driven wheels to propel the elevator car up and down on vertical I-beam tracks. Two elements to this system include the elevator car which will be guided by rollers guides on traditional T-rails, and the autonomous car mover which will house two (2) to four (4) motor-driven wheels. Goals of the connection between these elements include: (a) providing vertical stiffness to provide adequate retention and structure strength; (b) minimizing the transmission of structure-borne noise; and (c) allowing for relative motion of the car mover and the elevator car to minimize the material and installation cost of the I-beam track system.

### BRIEF SUMMARY

Disclosed is a ropeless elevator system including a car mover operationally connected to an elevator car, the car mover configured to operate autonomously and move along a hoistway lane, thereby moving the elevator car along the hoistway lane, wherein the car mover is connected to a top or bottom of the elevator car, via a coupling device.

In addition to one or more aspects of the system, or as an alternate, the car mover is connected to the elevator car via the coupling device, wherein the coupling device is one or more of: one or more vibration isolating pads; and one or more bearings.

In addition to one or more aspects of the system, or as an alternate, the car mover is connected to the elevator car via the coupling device, wherein the coupling device includes linear bearings that are positioned orthogonal to each other and a thrust bearing positioned orthogonal to the linear bearings.

In addition to one or more aspects of the system, or as an alternate, the car mover is connected to the elevator car via the coupling device, wherein the coupling device includes one or more link members, wherein each link member includes revolute joint ends spaced apart from each other by the link member.

In addition to one or more aspects of the system, or as an alternate, the revolute joint ends are respective defined as spherical ends; and mounting brackets respectively surrounding ones of the revolute joint ends so that the revolute joint ends are configured to pivot within the respective mounting brackets.

In addition to one or more aspects of the system, or as an alternate, within the mounting brackets, the respective revolute joint ends are surrounded by a vibration isolator material.

In addition to one or more aspects of the system, or as an alternate, the car mover is connected to the top of the elevator car via the coupling device, wherein the coupling device includes one or more flexible rods mounted between the car mover and an elevator car platform.

In addition to one or more aspects of the system, or as an alternate, the car mover is connected to the elevator car via the coupling device, and a sensor is connected to the coupling device.

In addition to one or more aspects of the system, or as an alternate, the sensor is configured to provide sensor data indicative of one or more of: a normal operating condition; an alert operating condition for the coupling device; and a distance between the car mover and the elevator car.

In addition to one or more aspects of the system, or as an alternate, the system is configured to engage a normal brake or an emergency brake when the sensor data is indicative of the alert operating condition.

In addition to one or more aspects of the system, or as an alternate, the sensor is configured to transmit the sensor data to one or more of a controller and a cloud service.

In addition to one or more aspects of the system, or as an alternate, the sensor is configured to transmit the sensor data via a wired connection or over a wireless network.

In addition to one or more aspects of the system, or as an alternate, the sensor data is indicative of a distance between the car mover and the elevator car, and the system is configured to identify an alert condition by comparing the sensor data against a threshold.

In addition to one or more aspects of the system, or as an alternate, the car mover is a beam climber that includes motorized wheels configured to drive against beams secured in the hoistway lane to thereby move the elevator car in the hoistway lane.

Further disclosed is a method of operating a ropeless elevator system, including: connecting a car mover to an elevator car in a hoistway lane via a coupling device, identifying from sensor data, via a sensor connected to the coupling device, one or more of a normal operating condition and an alert operating condition of the coupling device.

In addition to one or more aspects of the method, or as an alternate, the method includes the system engaging a normal brake or an emergency brake when sensor data from the sensor is indicative of the alert operating condition.

In addition to one or more aspects of the method, or as an alternate, the sensor is configured to measure one or more of strain, vibrations and a gap between the elevator car and the car mover

In addition to one or more aspects of the method, or as an alternate, the method includes one or more of: the sensor transmitting the sensor data via a wired connection or over a wireless network; and the sensor transmitting the sensor data to one or more of a controller and a cloud service.

In addition to one or more aspects of the method, or as an alternate, the method includes system identifying an alert condition by comparing the sensor data, indicative of a distance between the car mover and the elevator car, against a threshold.

In addition to one or more aspects of the method, or as an alternate, the car mover is a beam climber that includes motorized wheels configured to drive against beams secured in the hoistway lane to thereby move the elevator car in the hoistway lane.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic of elevator cars and car movers in a hoistway lane according to an embodiment;

FIG. 2 shows a car mover according to an embodiment;

FIG. 3A shows a car mover and a car connected to each other with a coupling device, where the coupling device is a link with revolute ends, with the car mover below the car;

FIG. 3B shows a car mover and a car connected to each other with a coupling device, where the coupling device is a link with revolute ends, with the car mover above the car;

FIG. 4 again shows a car mover and a car connected to each other with a coupling device, where the coupling device is a link with revolute ends, with the car mover below the car;

FIG. 5 shows a coupling device according to an embodiment, where the coupling device is a link with revolute ends;

FIG. 6 shows a car mover and a car directly connected to each other, with the car mover below the car;

FIG. 7 shows a car mover and a car connected to each other with a coupling device, where the coupling device is an iso pad, with the car mover below the car;

FIG. 8 shows a car mover and a car connected to each other with a coupling device, where the coupling device is a plurality of iso pads, with the car mover below the car;

FIG. 9 shows a car mover and a car connected to each other with a coupling device, where the coupling device is a set of bearings, with the car mover below the car;

FIG. 10 shows a car mover and a car connected to each other with a coupling device, where the coupling device is the link of FIG. 5, with the car mover below the car;

FIG. 11 shows a car mover and a car connected to each other with a coupling device, where the coupling device is a plurality of the links of FIG. 5, with the car mover below the car;

FIG. 12 shows a car mover and a car connected to each other with a coupling device, where the coupling device is a plurality of flexible rods, with the car mover below the car;

FIG. 13 is a flowchart showing a method of operating an elevator system according to an embodiment.

### DETAILED DESCRIPTION

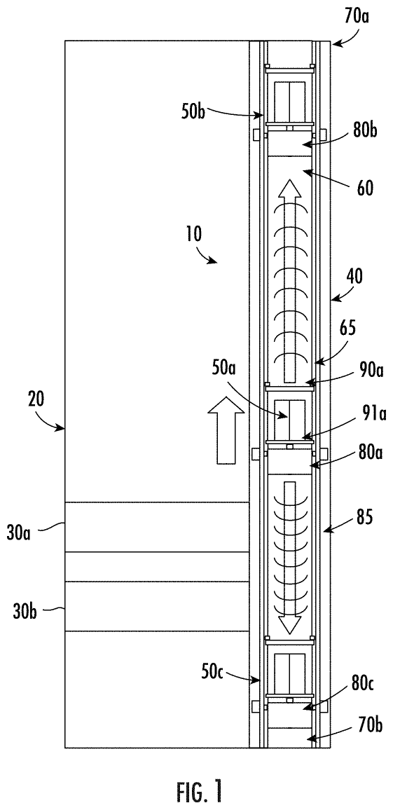

FIG. 1 depicts a self-propelled or ropeless elevator system (elevator system) 10 in an exemplary embodiment that may be used in a structure or building 20 having multiple levels or floors 30a, 30b. Elevator system 10 includes a hoistway 40 (or elevator shaft) defined by boundaries carried by the building 20, and a plurality of cars 50a-50c adapted to travel in a hoistway lane 60 along an elevator car track 65 (which may be a T-rail) in any number of travel directions (e.g., up and down). The cars 50a-50c are generally the same so that reference herein shall be to the elevator car 50a. The hoistway 40 may also include a top end terminus 70a and a bottom end terminus 70b.

For each of the cars 50a-50c, the elevator system 10 includes one of a plurality of car mover systems (car movers) 80a-80c (otherwise referred to as a beam climber system, or beam climber, for reasons explained below). The car movers 80a-80c are generally the same so that reference herein shall be to the car 50a. The car mover 80a is configured to move along a car mover track 85 (which may be an I-beam) to move the elevator car 50a along the hoistway lane 60, and to operate autonomously. The car mover 80a may positioned to engage the top 90a of the car 50a, the bottom 91a of the car 50a or both. In FIG. 1, the car mover 80a engages the bottom 91a of the car 50a.

FIG. 2 is a perspective view of an elevator system 10 including the elevator car 50a, a car mover 80a, a controller 115, and a power source 120. Although illustrated in FIG. 1 as separate from the car mover 80a, the embodiments described herein may be applicable to a controller 115 included in the car mover 80a (i.e., moving through an hoistway 40 with the car mover 80a) and may also be applicable to a controller located off of the car mover 80a (i.e., remotely connected to the car mover 80a and stationary relative to the car mover 80a).

Although illustrated in FIG. 1 as separate from the car mover 80a, the embodiments described herein may be applicable to a power source 120 included in the car mover 80a (i.e., moving through the hoistway 40 with the car mover 80a) and may also be applicable to a power source located off of the car mover 80a (i.e., remotely connected to the car mover 80a and stationary relative to the car mover 80a).

The car mover 80a is configured to move the elevator car 50a within the hoistway 40 and along guide rails 109a, 109b that extend vertically through the hoistway 40. In an embodiment, the guide rails 109a, 109b are T-beams. The car mover 80a includes one or more electric motors 132a, 132b. The electric motors 132a, 132b are configured to move the car mover 80a within the hoistway 40 by rotating one or more motorized wheels 134a, 134b that are pressed against a guide beam 111a, 111b that form the car mover track 85 (FIG. 1).

In an embodiment, the guide beams 111a, 111b are I-beams. It is understood that while an I-beam is illustrated any beam or similar structure may be utilized with the embodiment described herein. Friction between the wheels 134a, 134b, 134c, 134d driven by the electric motors 132a, 132b allows the wheels 134a, 134b, 134c, 134d climb up 21 and down 22 the guide beams 111a, 111b. The guide beam extends vertically through the hoistway 40. It is understood that while two guide beams 111a, 111b are illustrated, the embodiments disclosed herein may be utilized with one or more guide beams. It is also understood that while two electric motors 132a, 132b are illustrated, the embodiments disclosed herein may be applicable to car movers 80a having one or more electric motors. For example, the car mover 80a may have one electric motor for each of the four wheels 134a, 134b, 134c, 134d. The electrical motors 132a, 132b may be permanent magnet electrical motors, asynchronous motor, or any electrical motor known to one of skill in the art. In other embodiments, not illustrated herein, another configuration could have the powered wheels at two different vertical locations (i.e., at bottom and top of an elevator car 50a).

The first guide beam 111a includes a web portion 113a and two flange portions 114a. The web portion 113a of the first guide beam 111a includes a first surface 112a and a second surface 112b opposite the first surface 112a. A first wheel 134a is in contact with the first surface 112a and a second wheel 134b is in contact with the second surface 112b. The first wheel 134a may be in contact with the first surface 112a through a tire 135 and the second wheel 134b may be in contact with the second surface 112b through a tire 135. The first wheel 134a is compressed against the first surface 112a of the first guide beam 111a by a first compression mechanism 150a and the second wheel 134b is compressed against the second surface 112b of the first guide beam 111a by the first compression mechanism 150a. The first compression mechanism 150a compresses the first wheel 134a and the second wheel 134b together to clamp onto the web portion 113a of the first guide beam 111a.

The first compression mechanism 150a may be a metallic or elastomeric spring mechanism, a pneumatic mechanism, a hydraulic mechanism, a turnbuckle mechanism, an electromechanical actuator mechanism, a spring system, a hydraulic cylinder, a motorized spring setup, or any other known force actuation method.

The first compression mechanism 150a may be adjustable in real-time during operation of the elevator system 10 to control compression of the first wheel 134a and the second wheel 134b on the first guide beam 111a. The first wheel 134a and the second wheel 134b may each include a tire 135 to increase traction with the first guide beam 111a.

The first surface 112a and the second surface 112b extend vertically through the hoistway 40, thus creating a track for the first wheel 134a and the second wheel 134b to ride on. The flange portions 114a may work as guardrails to help guide the wheels 134a, 134b along this track and thus help prevent the wheels 134a, 134b from running off track.

The first electric motor 132a is configured to rotate the first wheel 134a to climb up 21 or down 22 the first guide beam 111a. The first electric motor 132a may also include a first motor brake 137a to slow and stop rotation of the first electric motor 132a.

The first motor brake 137a may be mechanically connected to the first electric motor 132a. The first motor brake 137a may be a clutch system, a disc brake system, a drum brake system, a brake on a rotor of the first electric motor 132a, an electronic braking, an Eddy current brakes, a Magnetorheological fluid brake or any other known braking system. The beam climber system 130 may also include a first guide rail brake 138a operably connected to the first guide rail 109a. The first guide rail brake 138a is configured to slow movement of the beam climber system 130 by clamping onto the first guide rail 109a. The first guide rail brake 138a may be a caliper brake acting on the first guide rail 109a on the beam climber system 130, or caliper brakes acting on the first guide rail 109 proximate the elevator car 50a.

The second guide beam 111b includes a web portion 113b and two flange portions 114b. The web portion 113b of the second guide beam 111b includes a first surface 112c and a second surface 112d opposite the first surface 112c. A third wheel 134c is in contact with the first surface 112c and a fourth wheel 134d is in contact with the second surface 112d. The third wheel 134c may be in contact with the first surface 112c through a tire 135 and the fourth wheel 134d may be in contact with the second surface 112d through a tire 135. A third wheel 134c is compressed against the first surface 112c of the second guide beam 111b by a second compression mechanism 150b and a fourth wheel 134d is compressed against the second surface 112d of the second guide beam 111b by the second compression mechanism 150b. The second compression mechanism 150b compresses the third wheel 134c and the fourth wheel 134d together to clamp onto the web portion 113b of the second guide beam 111b.

The second compression mechanism 150b may be a spring mechanism, turnbuckle mechanism, an actuator mechanism, a spring system, a hydraulic cylinder, and/or a motorized spring setup. The second compression mechanism 150b may be adjustable in real-time during operation of the elevator system 10 to control compression of the third wheel 134c and the fourth wheel 134d on the second guide beam 111b. The third wheel 134c and the fourth wheel 134d may each include a tire 135 to increase traction with the second guide beam 111b.

The first surface 112c and the second surface 112d extend vertically through the shaft 117, thus creating a track for the third wheel 134c and the fourth wheel 134d to ride on. The flange portions 114b may work as guardrails to help guide the wheels 134c, 134d along this track and thus help prevent the wheels 134c, 134d from running off track.

The second electric motor 132b is configured to rotate the third wheel 134c to climb up 21 or down 22 the second guide beam 111b. The second electric motor 132b may also include a second motor brake 137b to slow and stop rotation of the second motor 132b. The second motor brake 137b may be mechanically connected to the second motor 132b. The second motor brake 137b may be a clutch system, a disc brake system, drum brake system, a brake on a rotor of the second electric motor 132b, an electronic braking, an Eddy current brake, a Magnetorheological fluid brake, or any other known braking system. The beam climber system 130 includes a second guide rail brake 138b operably connected to the second guide rail 109b. The second guide rail brake 138b is configured to slow movement of the beam climber system 130 by clamping onto the second guide rail 109b. The second guide rail brake 138b may be a caliper brake acting on the first guide rail 109a on the beam climber system 130, or caliper brakes acting on the first guide rail 109 proximate the elevator car 50a.

The elevator system 10 may also include a position reference system 113. The position reference system 113 may be mounted on a fixed part at the top of the hoistway 40, such as on a support or guide rail 109, and may be configured to provide position signals related to a position of the elevator car 50a within the hoistway 40. In other embodiments, the position reference system 113 may be directly mounted to a moving component of the elevator system (e.g., the elevator car 50a or the car mover 80a), or may be located in other positions and/or configurations.

The position reference system 113 can be any device or mechanism for monitoring a position of an elevator car within the elevator shaft 117. For example, without limitation, the position reference system 113 can be an encoder, sensor, accelerometer, altimeter, pressure sensor, range finder, or other system and can include velocity sensing, absolute position sensing, etc., as will be appreciated by those of skill in the art.

The controller 115 may be an electronic controller including a processor 116 and an associated memory 119 comprising computer-executable instructions that, when executed by the processor 116, cause the processor 116 to perform various operations. The processor 116 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 119 may be but is not limited to a random access memory (RAM), read only memory (ROM), or other electronic, optical, magnetic or any other computer readable medium.

The controller 115 is configured to control the operation of the elevator car 50a and the car mover 80a. For example, the controller 115 may provide drive signals to the car mover 80a to control the acceleration, deceleration, leveling, stopping, etc. of the elevator car 50a.

The controller 115 may also be configured to receive position signals from the position reference system 113 or any other desired position reference device.

When moving up 21 or down 22 within the hoistway 40 along the guide rails 109a, 109b, the elevator car 50a may stop at one or more floors 30a, 30b as controlled by the controller 115. In one embodiment, the controller 115 may be located remotely or in the cloud. In another embodiment, the controller 115 may be located on the car mover 80a

The power supply 120 for the elevator system 10 may be any power source, including a power grid and/or battery power which, in combination with other components, is supplied to the car mover 80a. In one embodiment, power source 120 may be located on the car mover 80a. In an embodiment, the power supply 120 is a battery that is included in the car mover 80a.

The elevator system 10 may also include an accelerometer 107 attached to the elevator car 50a or the car mover 80a. The accelerometer 107 is configured to detect an acceleration and/or a speed of the elevator car 50a and the car mover 80a.

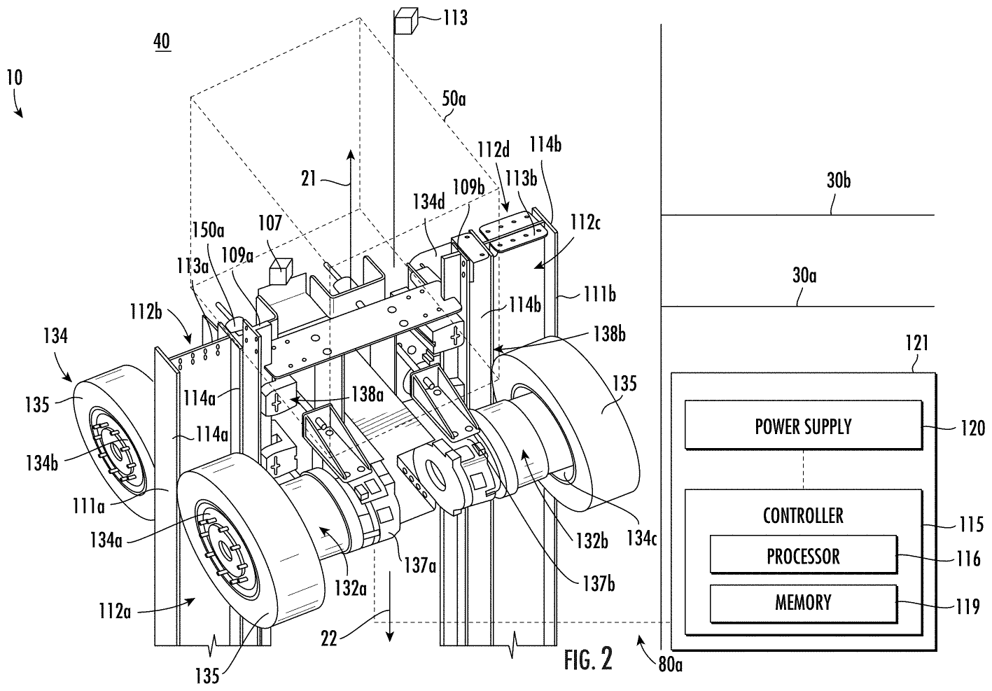

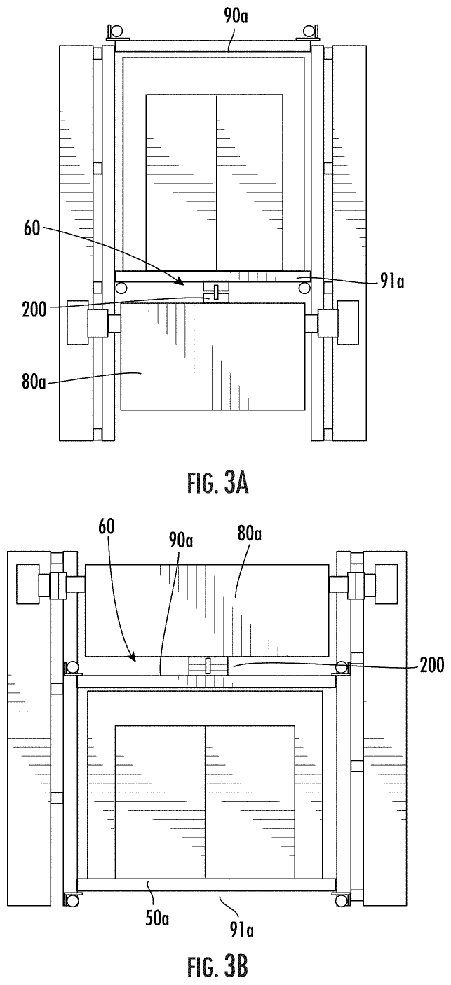

In FIG. 3A, the car mover 80a and a car 50a are connected to each other in the hoistway lane 60 via a coupling device 200. The coupling device 200 is a link with revolute ends. The car mover 80a in this figure is below the car 50a. In FIG. 3B, the car mover 80a and a car 50a are connected to each other in the hoistway lane 60 via the coupling device 200. The coupling device 200 is a link with revolute ends. The car mover 80a in this figure is above the car 50a.

Turning to FIGS. 4-5, as indicated, goals of the connection between the car 50a and the car mover 80a, which may be facilitated via the coupling device 200, include: (a) providing vertical stiffness to provide adequate retention and structure strength; (b) minimizing the transmission of structure-borne noise; and (c) allowing for relative motion of the car mover and the elevator car. Thus, the disclosed embodiments provide a coupling device 200 for the car 50a and the car mover 80a. The disclosed coupling device 200 may be utilized in a car mover 80a mounted to the bottom 91a (FIG. 3) or top 90a (FIG. 4) of the elevator car 50a, defining an underslung or over slung systems.

As shown in FIG. 5, the coupling device 200 includes a coupling link member 210 mounted between the car 50a and the car mover 80a with top and bottom revolute joint ends 220a, 220b defining respective top and bottom ends of the coupling link member 210. This configuration allows the car mover 80a to move relative to the car 50a along multiple linear and rotational axises of motion, except, e.g., vertically.

In one embodiment, the revolute joint ends 220a, 220b, are formed by spherical balls of an otherwise rod shaped member that defines the link member 210. In addition, engaging the revolute joint ends 220a, 220b are respective top and bottom metallic mounting brackets 230a, 230b to ensure the coupling link member 210 is retained in the event of failure of either the top or bottom revolute joint ends 220a, 220b. The brackets 230a, 230b are substantially the same so that a further discussion is directed to the top bracket 230a for simplicity. The bracket 230a has a cup shaped portion 240, with a center opening 250 through which the link member 210 extends. The center opening 250 is smaller than a diameter of the spherical balls of the revolute joint ends 220a, 220b to prevent disengagement. A plate shaped portion 260 at the mouth of the cup shaped portion 240 is configured for mounting to the car mover 80a or car 50a. The revolute joint ends 220a, 220b can be either metal on metal joints or can be flexible (flex) joints. To function as a vibration isolator material 270, grease, rubber or polyurethane may be filled in the cup shaped member, around the revolute joint ends 220a to attenuate structure borne energy, e.g., vibrational energy.

A sensor 300, which may be contacting or non-contacting, could also be included to provide sensor data indicative of any one of a plurality of parameters to determine if the coupling device 200 is operating normally or, outside of a threshold, e.g. due to a potential part failure. For example, the sensor 300 may measure strain or vibration or a running gap 310 between the revolute joint ends 220a, 220b, to detect joint failure while allowing a run to be completed. The sensor 300 may be a load senor or strain gauge load weighing and pre-torque control. The load cell could detect the load in elevator car and the structural integrity of the connection. The sensor 300 may be able to provide information indicative of the distance between the car mover and the elevator car, which may be indicative of a structural integrity of the connection.

The sensor 300 may communicate via wired or wireless connection (discussed in greater detail below) with the controller 115 (FIG. 2). Alternatively, one or more of the sensor 300 and controller 115 may communicate via a wireless or wired network connection 320 with a cloud service 330. The analysis of the sensor data may be in whole or part on any one of the sensor 300 (using edge computing), the controller 115 or the cloud service 330 to determine whether an alert condition exists, e.g., due to a potential or actual failure of the coupling device 200. If an alert condition exits, the system 10, via e.g., the controller 115, may stop the elevator car 50a via a normal braking or alert braking operation or providing an alert to a building maintenance worker. As indicated, a utilization of the sensor 300 may be to obtain load information which may be utilized for the system to pre-torque the on-board motors (e.g., 132a), to avoid rollback when the brakes are dropped as the car 50a leaves a floor.

Wireless connections may apply protocols that include local area network (LAN, or WLAN for wireless LAN) protocols and/or a private area network (PAN) protocols. LAN protocols include WiFi technology, based on the Section 802.11 standards from the Institute of Electrical and Electronics Engineers (IEEE). PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. Such wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz—typically in the 769-935 MHz, 315 Mhz and the 468 Mhz frequency range. This spectrum band below 1 Ghz is particularly useful for RF IOT (internet of things) applications. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

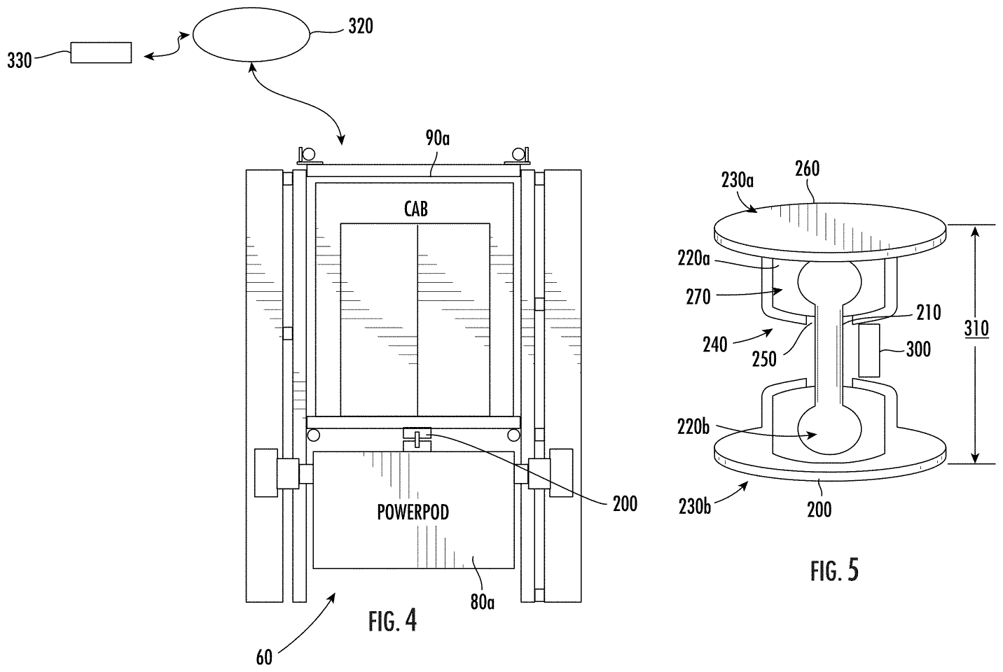

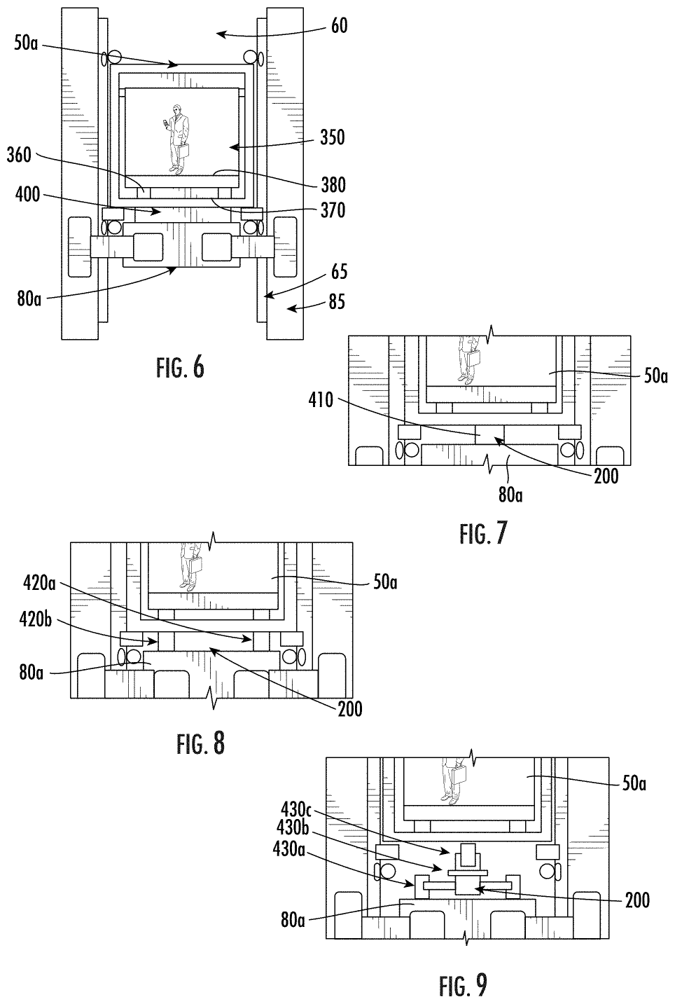

In FIGS. 6-12, seven (7) different coupling embodiments are illustrated to address coupling the car mover 80a to the car 50a. In each of these figures, the elevator car 50a is in the hoistway lane 60. The elevator car 50a travels on the car tack 65 and the car mover travels on the car mover track 85 A passenger compartment 350 is supported within the elevator car 50a by motion dampers 360, secured between the elevator car platform 370 and the passenger compartment platform 380. The motion dampers 360 are known in the industry as isolation pads or iso-pads. Iso-pads have a relatively large vertical translational stiffness and a relatively low stiffnesses in other movement directions (e.g., linear and rotational degrees-of-freedom (DOF)), i.e., for damping vibrations from rail misalignments and dampen noise.

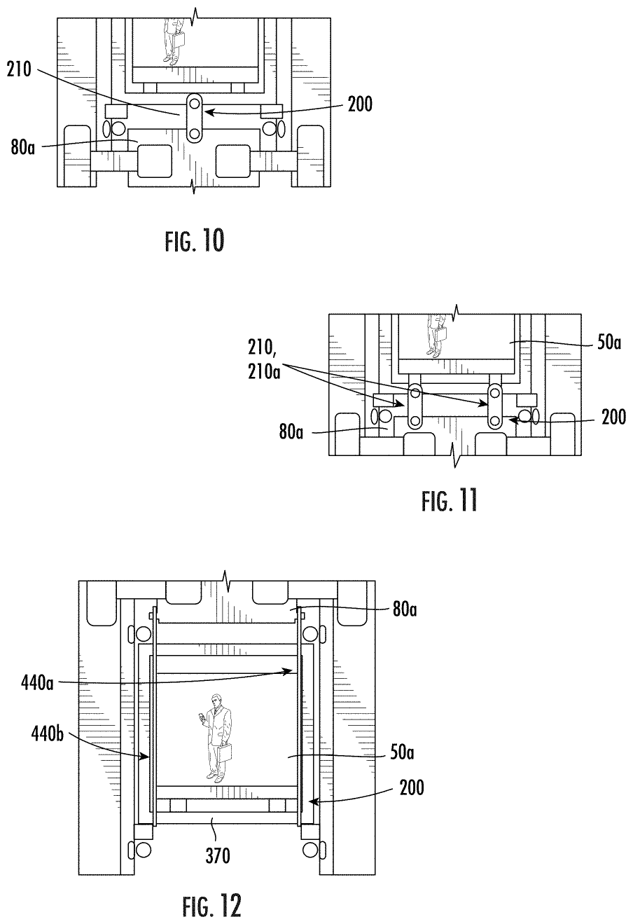

FIG. 6 shows a rigid coupling 400 between the car mover 80a and the car 50a, which meets structural integrity requirements. FIG. 7 couples the car mover 80a to the car 50a via an iso pad 410 as the coupling device 200. FIG. 8 incorporates one or more iso pads and in particular a plurality of the iso pads 420a, 420b as the coupling device 200 between the car mover 80a and the car 50a to further dampen vibrationally induced noise and motion compared with a single iso pad 410. This reduces the degrees of freedom of low stiffness degrees motion between the car mover 80a and car 50a to three (3) or four (4). FIG. 9 includes one or more bearings and in particular linear bearings 430a, 430b as part of the coupling device 200 positioned to allow relative movement between the car mover 80a and car 50a in front-back and side-side directions, i.e., in the horizontal plane. In addition, a thrust bearing 430c as part of the coupling device 200 between the car mover 80a and the car 50a provides relative motion between the car mover 80a and car 50a in the vertical direction. The combination of each linear bearing and the thrust bearing provides for five (5) degrees of freedom of low stiffness motion between the car mover 80a and car 50a. FIG. 10 shows the embodiment illustrated in FIG. 3-5, e.g., with a link member 210 with revolute joint ends 220a, 220b, as the coupling device 200 between the car mover 80a and the car 50a that provides five (5) degrees of freedom of low stiffness degrees motion between the car mover 80a and car 50a. FIG. 11 shows is a one or more of the link members 210, and in particular a plurality of the link members 210, 210a, of the configuration of FIGS. 3-5 between the car mover 80a and the car 50a, reducing the degrees of freedom of low stiffness between the car mover 80a and car 50a to (3) three or (4) four. FIG. 12 shows one or more flexible rods and in particular a plurality of flexible rods 44a, 440b as the coupling device 200 are connected between the car mover 80a and the car platform 370 to reduce the degrees of freedom of low stiffness between the car mover 80a and car 50a to three (3) or four (4).

In FIGS. 6-11, the car mover 80a may be under or over the car 50a, while in FIG. 12 the car mover 80a is over the top of the car 50a. The coupling devices 200 allow for relative motion between the car mover 80a and the car 50a to minimize the impact of rail misalignments between guide rails (for the car 50a) and I-beams (for the car mover 80a) utilized for the propulsion system, while also providing adequate vertical translational stiffness, to ensure structural integrity and force transfer between the car mover 80a and the car 50a.

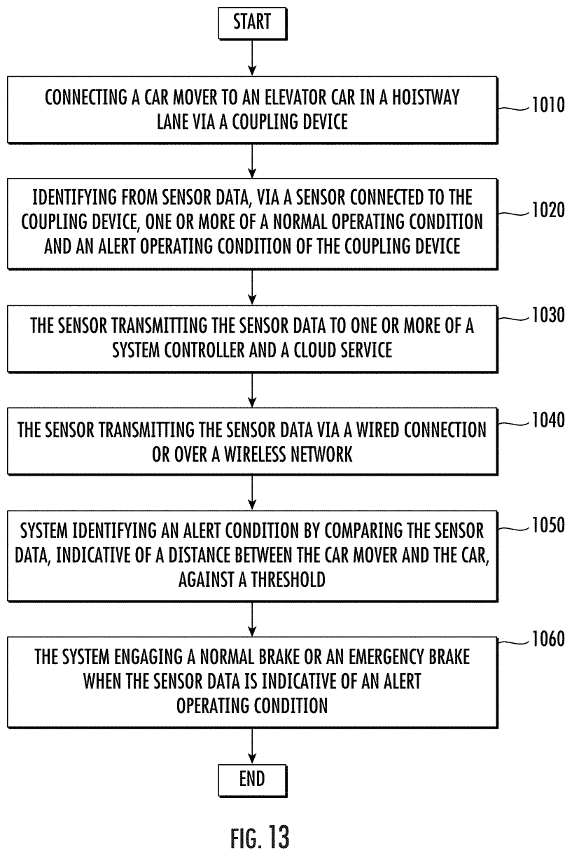

Tuning to FIG. 13, a flowchart shows a method is of operating an elevator system 10. As shown in block 1010, the method includes connecting a car mover 80a to an elevator car 50a in a hoistway lane 60 via a coupling device 200. As shown in block 1020, the method includes identifying from sensor data, via a sensor 300 connected to the coupling device 200, one or more of a normal operating condition and an alert operating condition of the coupling device 200. As shown in block 1030, the method includes the sensor 300 transmitting the sensor data to one or more of a controller 115 and a cloud service 330. As shown in block 1040, the method includes the sensor 300 transmitting the sensor data via a wired connection or over a wireless network 320. As shown in block 1050, the method includes the system 10 identifying an alert condition by comparing the sensor data, indicative of a distance between the car mover 80a and the car 50a, against a threshold. As shown in block 1060, the method includes the system 10 engaging a normal brake or an emergency brake when the sensor data is indicative of an alert operating condition.

The disclosed embodiments addresses two goals for the car mover 80a: minimizing in-car noise and vibration levels; and providing a cost-competitive propulsion system. To minimize air-borne noise, the motors 132a, 132b (FIG. 2) in the car mover 80a are encase with a sound isolation box. To minimize structure-borne noise and vibration, this disclosed embodiments isolate the car mover 80a and the car 50a from each other with respect to vibrations that may be damped out via the coupling device 200, and other disclosed coupling configurations, while allowing for relative motion between the car mover 80a and car 50a. The coupling device 200, and the other disclosed coupling configurations, therefore reduce a need for relatively tight tolerances with respect to a tracking control between the car mover 80a track and the car 50a track. This may reduce the cost and installation complexity of the elevator system 10.

As described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A ropeless elevator system comprising:
a car mover operationally connected to an elevator car, the car mover configured to operate autonomously and move along a hoistway lane, thereby moving the elevator car along the hoistway lane,
wherein the car mover is connected to a top or bottom of the elevator car, via a coupling device.

2. The system of claim 1, wherein:
the car mover is connected to the elevator car via the coupling device, wherein the coupling device is one or more of:
one or more vibration isolating pads; and
one or more bearings.

3. The system of claim 1, wherein:
the car mover is connected to the elevator car via the coupling device, wherein the coupling device includes linear bearings that are positioned orthogonal to each other and a thrust bearing positioned orthogonal to the linear bearings.

4. The system of claim 1, wherein:
the car mover is connected to the elevator car via the coupling device, wherein the coupling device includes one or more link members, wherein each link member includes revolute joint ends spaced apart from each other by the link member.

5. The system of claim 4, wherein:
the revolute joint ends are respective defined as spherical ends; and
mounting brackets respectively surrounding ones of the revolute joint ends so that the revolute joint ends are configured to pivot within the respective mounting brackets.

6. The system of claim 5, wherein, within the mounting brackets, the respective revolute joint ends are surrounded by a vibration isolator material.

7. The system of claim 1, wherein:
the car mover is connected to the top of the elevator car via the coupling device, wherein the coupling device includes one or more flexible rods mounted between the car mover and an elevator car platform.

8. The system of claim 1, wherein:
the car mover is connected to the elevator car via the coupling device, and a sensor is connected to the coupling device.

9. The system of claim 8, wherein:
the sensor is configured to provide sensor data indicative of one or more of:
a normal operating condition;
an alert operating condition for the coupling device; and
a distance between the car mover and the elevator car.

10. The system of claim 8, wherein the system is configured to engage a normal brake or an emergency brake when the sensor data is indicative of the alert operating condition.

11. The system of claim 8, wherein the sensor is configured to transmit the sensor data to one or more of a controller and a cloud service.

12. The system of claim 8, wherein the sensor is configured to transmit the sensor data via a wired connection or over a wireless network.

13. The system of claim 8, wherein the sensor data is indicative of a distance between the car mover and the elevator car, and the system is configured to identify an alert condition by comparing the sensor data against a threshold.

14. The system of claim 1, wherein:
the car mover is a beam climber that includes motorized wheels configured to drive against beams secured in the hoistway lane to thereby move the elevator car in the hoistway lane.

15. A method of operating a ropeless elevator system, comprising:
connecting a car mover to an elevator car in a hoistway lane via a coupling device,
identifying from sensor data, via a sensor connected to the coupling device, one or more of a normal operating condition and an alert operating condition of the coupling device.

16. The method of claim 15, comprising:
the system engaging a normal brake or an emergency brake when sensor data from the sensor is indicative of the alert operating condition.

17. The method of claim 15, wherein:
the sensor is configured to measure one or more of strain, vibrations and a gap between the elevator car and the car mover

18. The method of claim 15, comprising one or more of:
the sensor transmitting the sensor data via a wired connection or over a wireless network; and
the sensor transmitting the sensor data to one or more of a controller and a cloud service.

19. The method of claim 15, comprising:
system identifying an alert condition by comparing the sensor data, indicative of a distance between the car mover and the elevator car, against a threshold.

20. The method of claim 15, wherein:
the car mover is a beam climber that includes motorized wheels configured to drive against beams secured in the hoistway lane to thereby move the elevator car in the hoistway lane.
